(19) United States
(12) Patent Application Publication
(10) Pub. No.: US 2017/0147885 A1
(43) Pub. Date: May 25, 2017

(54) Heat-Based Human Presence Detection and Tracking

(71) Applicants: Anant Aggarwal, Waltham, MA (US); Christian Breuer, Dortmund (DE)

(72) Inventors: Anant Aggarwal, Waltham, MA (US); Christian Breuer, Dortmund (DE)

(73) Assignee: OSRAM SYLVANIA Inc., Wilmington, MA (US)

(21) Appl. No.: 15/422,543

(22) Filed: Feb. 2, 2017

Related U.S. Application Data
(63) Continuation-in-part of application No. 14/076,372, filed on Nov. 11, 2013.

(51) Int. Cl. G06K 9/00; G06T 7/246; H04N 7/18; G06N 5/04; H04N 5/33

(52) U.S. Cl. CPC G06K 9/00778; G06N 5/04; H04N 5/33; H04N 7/183; G06K 9/00369; G06T 7/248; G06K 9/00342; G06T 2207/10048; G06T 2207/30196; G06T 2207/30232; G06T 5/002

(57) ABSTRACT

Techniques are disclosed for detecting human presence using IR sensor data. In some embodiments, any activity in a space monitored (imaged) by an IR sensor can be determined by calculating the delta between average image frames acquired by the imaging sensor. A finite value of delta implies activity/presence. In some embodiments, the delta values (i.e., changes in target area scene) are integrated over time to calculate a mask. The mask can be used to isolate a human occupant (whether stationary or moving) in the scene from the given background objects of the space, thus allowing for occupancy detection. Occupancy in known blind spots of the area can be inferred based on detected occupancy in non-blind spots neighboring the blind spot so that entering and exiting with respect to the blind spot is tracked.

### RELATED APPLICATION

This application is a continuation-in-part of U.S. application Ser. No. 14/076,372, entitled “Human Presence Detection,” filed Nov. 11, 2013, which is herein incorporated by reference in its entirety.

### FIELD OF THE DISCLOSURE

This disclosure relates to presence detection techniques, and more specifically to intelligent output control systems capable of detecting and tracking human presence, such as intelligent control systems for lighting, surveillance, HVAC, and safety/alarm applications.

### BACKGROUND

In spatial occupancy systems, acoustic motion sensors and infrared (IR) sensors may be used to detect a human presence within a scanned space. Accurately detecting a human presence while avoiding false triggers involves a number of non-trivial challenges.

### BRIEF DESCRIPTION OF THE DRAWINGS

FIG. 1 is a graph of the temperature over time of a room having a cyclical heat source, such as an HVAC system.

FIG. 2 is a graph of the temperature over time of a room having a human entering and leaving the room.

FIG. 3 illustrates the calculation of a delta frame after one minute, according to an embodiment of the present disclosure.

FIG. 4 shows an IR frame, delta frame, and mask frame of a room at various time intervals, according to one embodiment of the present disclosure.

FIG. 5 shows an IR frame, delta frame, and mask frame of a room at various time intervals, according to another embodiment of the present disclosure.

FIG. 6a shows an IR frame, delta frame, mask frame, and digital mask frame of a room at various time intervals, according to one embodiment of the present disclosure.

FIG. 6b shows an IR frame, delta frame, mask frame, and digital mask frame of a room at various time intervals, according to another embodiment of the present disclosure.

FIG. 7a illustrates a method for detecting stationary human presence, according to an embodiment of the present disclosure.

FIG. 7b illustrates an example system that can carry out the method of FIG. 7a, according to an embodiment of the present disclosure.

FIG. 8a illustrates an example field of view of an IR grid array sensor, in accordance with an embodiment of the present disclosure.

FIG. 8b illustrates an example sensor map as it relates to a field of view of an IR grid array sensor, in accordance with an embodiment of the present disclosure.

FIGS. 8c-8e each illustrates sensor detection signals from pixel regions representing the field of view (FOV), in accordance with an embodiment of the present disclosure.

### DETAILED DESCRIPTION

Techniques are disclosed for detecting and tracking human presence using IR sensor data. A number of IR images of a given area being monitored may be captured using an IR sensor and these IR images may be averaged over various time intervals to calculate a number of average IR frames. The difference between these average IR frames provides a delta frame, and the value of the delta frame may be used to detect activity or human presence within the scanned area. In some embodiments, any delta value indicative of a significant change in heat signature may activate the presence detection system. In some cases, a local activity may be detected based on the location of the delta value within the delta frame, and the dimensions of the delta frame may be determined by the pixel count of the IR sensor. To this end, certain pixels of the IR sensor may correspond to certain locations within the area being monitored (e.g., room), although at least some of the sensor pixels may be able to see the entire area, depending on factors such as the size of the area, obstacles within the area, and the FOV of a given IR sensor. As will be further appreciated in light of this disclosure, a mask frame may be calculated as the summation of delta frames over time. The value of the mask frame may be used to detect a stationary human presence even when no delta value is calculated (e.g., because the person is sitting still). Note that the value of the mask frame can be an overall value of the entire mask frame (i.e., all pixel values of the entire frame), or a partial value of the entire mask frame (i.e., only some of the pixel values of the entire frame), or some other representative value of the mask frame. To this end, the dimensions of the mask frame can be determined by the pixel count of the IR sensor, and a local presence can therefore be detected based on the location of the pixel value(s) within the mask frame. In some such embodiments, a digital mask frame may be calculated as a binary representation of the mask frame and a stationary human presence may be determined based on the value of the digital mask frame. So, for example, logical 1's can be used to indicate pixel values corresponding to an occupant and logical 0's can be used to indicate pixel values corresponding to no occupant. The mask frame may also be used to calculate a background frame that represents the IR signature of stationary or cyclical objects within the scanned area that are not intended to trigger the presence detection system (permanent or quasi-permanent objects present in the space, but not considered to be an occupant, such as a heating duct or a fish tank). Such a background frame thus can be used to show a baseline profile of the area to be monitored, in which the baseline shows how the area appears to the sensor with no occupancy. As such, any occupancy of the area can be readily detected by comparing a frame including an occupant against the background frame. For instance, the presence of a stationary occupant may be determined by subtracting the background frame from a current average IR frame. In addition, a given spatial environment can be segmented into a plurality of regions, each region corresponding to a cluster of pixels of an IR sensor observing the environment. Some regions may include objects that effectively hide the presence of an occupant, such as a door, cubicle wall, or a high-back chair or book shelf. Thus, and according to a further embodiment of the present disclosure, techniques are provided to estimate hidden human presence (stationary or in-motion) in a spatial environment by tracking the heat mass captured in segmented individual pixel clusters of an infrared image over time. Such techniques allow for occupancy determination even when the occupant becomes invisible/hidden within the observed space.

General Overview

As previously explained, spacial occupancy may be determined using passive infrared (PIR) sensors or ultrasonic sensors; however, these systems often rely on a fixed timeout counter and may be prone to false triggering. Each time motion is detected in the environment, the occupancy detection system turns the output on for a fixed period of time, for example five minutes, regardless of the actual duration of occupancy. This may lead to wasting energy as the output may stay on for much longer than necessary (e.g., even though the person has left the room, the lights remain on for the remainder of the fixed time period). Also, if a person remains relatively still, the lights may go off after the time limit has run, leaving the person in the dark, until they perform some detectable movement to re-trigger the lighting system. Furthermore, false triggering may occur from events such as flowing hot air (e.g., from a heating system) or cycling hot objects in the environment such as a machine or pet. In some cases, varying sunlight or shadows through windows, curtains, sunlit carpet or reflective surface, fireplace, etc. may all contribute to false triggering of IR sensors. In addition, imaging technologies such as depth sensors (e.g., Kinect), time-of-flight cameras, and visible imaging cameras are very powerful, but all require a line of sight to the human presence within the field of view (FOV). To this end, such systems are unable to sense presence of an occupant as soon as that occupant is visually blocked, hidden, or otherwise made invisible by an obstacle within the area being monitored (e.g., such as the case when the occupant moves to a location behind a door, a cubicle wall, or a high back chair), and therefore susceptible to blind spots within a spatially resolved environment. One way to solve the blind spot detection problem might include, for instance, using a global positioning system (GPS), but that would require each occupant to have a GPS receiver, and require a significant more amount of both processing and electrical power, relative to IR-based techniques.

Thus, in accordance with an embodiment of the present disclosure, human occupancy detection and tracking techniques are disclosed. The techniques can be implemented, for example, utilizing one or more infrared sensors operatively coupled to an infrared image processing block. The proposed techniques not only enable detection of stationary human presence, but also enable background estimation and masking out non-occupant objects in the spatial environment, as well as the tracking of a given occupant into blind spots of the spatial environment. Stationary human presence detection removes the need for occupants to periodically move or wave a hand in order to keep the system from turning off. In some embodiments, stationary human presence may include a person temporarily outside the field of view (FOV) of an IR sensor, such as behind a cubicle wall. In such cases, the system can track the person's movement into that blind spot, as well as detect the person's departure from that blind spot. Thus, the system is programmed or otherwise configured to understand that a person can still be present, even though that person is in a blind spot with respect to the IR sensor(s). Furthermore, the techniques provided herein allow the sensor-controlled output (e.g., for controlling lighting, air-conditioning, surveillance/monitoring, etc) to be turned off as soon as the space is vacant, as opposed to waiting until a fixed output period concludes, and thus provides increased energy efficiency and reduced computational load. Such techniques may be integrated, for example, with numerous systems, such as lighting, surveillance, HVAC, safety/alarm systems, etc.

In one embodiment, an IR sensor or camera may be mounted on a ceiling to create IR images or frames of a given room or target area. In one such example, the IR sensor includes an IR grid array (pixelated sensor of M×N pixels) and interfaces with a microcontroller or other suitable computing system capable of processing sensor image data. In other embodiments, multiple IR sensors may work in unison to scan an area, and there may be some overlap between sensors. In such an embodiment, multiple IR sensors at different angles within a room may allow for greater IR visibility such that a person is rarely out of the field of view of all the IR sensors (i.e., in a blind spot), although visibility of the entire room is not needed, as will be appreciated in light of this disclosure. The sensor(s) may send a fixed number of frames per second to the microcontroller (e.g., 4, 8, or 16 frames per second) for IR image processing, in some embodiments. Image processing may alternatively be offloaded or otherwise performed on a separate computer or processor that is in communication with the microcontroller, in other embodiments. The IR band selection associated with the IR sensor(s) in one embodiment is based on a number of factors including indoor/outdoor sensing, operating distance, temperature of object of interest, and the emissivity of the object of interest. In one specific example for indoor occupancy sensing, the far infrared wavelength range between 8-14 um is used, although other sensors capable of detecting a human heat signature can be used. Examples of suitable sensors include the Omron D6T-44L-06 (4×4), Panasonic “GridEYE” AMG8831 (8×8), or the Melexis MLX90620 (4×16) sensor. Numerous other suitable sensors will be apparent in light of this disclosure.

In one example embodiment, a rolling average of the IR image frames is calculated over each of different time periods and any activity in the given space may be determined by calculating the delta between average IR image frames. Averaging may be performed over various time increments and at various intervals, as will be appreciated. For example, a 1 second average (e.g., averaging 16 frames if the IR sensor captures 16 frames per second) or a 10 second average (averaging 160 frames) may be performed every minute. In one specific example embodiment, a 5-second average IR image frame may be calculated at time t=5 seconds and again at time t=10 seconds, and these two 5-second averages may be subtracted to find a delta frame value. As will be appreciated in light of this disclosure, averaging image frames and comparing averaged image frames to calculate a delta frame value may be performed at different time intervals and the averages may have different time lengths, in some embodiments. Averaging multiple image frames may also provide noise filtering, in some embodiments. A large number of IR image frames per second provides increased data as well as an increased amount of noise, and this noise may be reduced by taking multiple averages with a noise filtering buffer.

A given room may have a specific IR profile while vacant (baseline IR profile, including cyclical heat sources such as heating vents) and any additional heat source that is not part of the baseline profile will be detected by the IR sensor, creating a finite delta value that implies activity or at least occupancy. For example, if a room is vacant for three minutes before a person enters, the average IR image frames over 10 seconds, 30 seconds, 1 minute, and 2 minutes will be substantially equal (within a given tolerance) and the delta value between those average image frames will therefore be zero (within a given tolerance). After 3 minutes, however, a human enters the room and the human's body temperature creates a new IR image causing the delta value to be a positive real number because of the added human's heat signature. Thus, the average IR image frame that includes that human activity will have a relatively much higher value than occupant-free average image frames. As such, the delta frame computed using that occupant-indicating average image frame will have a value indicative of human occupancy. In response, the system can execute an appropriate lighting control, surveillance protocol, HVAC control, safety/alarm protocol or other action depending on the given application.

In some example embodiments, the detection of a significantly large delta value indicates activity/occupancy and may trigger the lights to turn on, while a mask frame is calculated over time to detect a stationary human presence and maintain the lights on. A mask frame can be calculated based on a plurality of delta frames over time. The threshold value for delta frame activity may depend on the specific application, and may be based on the heat signature of a human, as opposed to the discernible heat signatures of a pet, heater, laptop fan, etc. In one such example embodiment, the delta frame values (changes in IR scene) are integrated over time to compute a mask frame, such that non-occupant background activity (such as cycling warm objects) gets nullified by the delta summation and does not show up in the mask frame. Hence, the mask frame can be used to effectively “mask” out the baseline profile of the target area. However, typical human presence presents a non-zero value of delta and these areas clearly show up in the mask frame, essentially distinguishing between non-baseline occupants and baseline background objects.

In one specific example, a person enters a room and remains there for an hour without significant movement. In such an example, the delta value(s) of the pixel(s) associated with the stationary human will be zero but the overall value of the mask frame will remain a positive number (or negative, depending on how the comparison is done) reflecting the stationary human presence. Until the person leaves the room, the average mask frame value will remain a positive number and the lights remain on; but once the person leaves the room a negative delta frame value is calculated, the negative delta is added to the mask frame, and the lights may be shut off in a relatively timely fashion. The mask frame may thus distinguish a stationary human occupant in the scene from the background or any cyclical heat sources. In some embodiments, further mathematical processing may be performed on the IR image frames for background estimation and presence detection. In other embodiments, the delta summation may be divided up into individual pixel clusters, each pixel cluster including one or more pixels and corresponding to a specific location within the target area. Such pixelated-based segmentation of the target area being monitored can be used to detect a local presence (i.e., occupancy of a specific location within the overall target area).

As will further be appreciated in light of this disclosure, such pixelated-based segmentation of the target area being monitored can be also used to detect movement of an occupant into a blind spot of the target area. Thus, as long as the occupant has to re-enter the visible portion of the target area to leave that target area, the system knows that the target area is occupied. To this end, the IR sensors can be placed or otherwise commissioned so that any given blind spot does not include an unmonitored exit from the target area. Thus, the control system knows when the target area is occupied, even if occupant is located in a blind spot of the target area. In more detail, the imaging sensor grid (including a plurality of IR pixel sensors) may be segmented into multiple localized regions, such that each region of the space to be monitored is associated with at least one pixel of the sensor grid. Once human presence is detected in the field of view, it is resolved into these small localized regions. Motion is tracked from one region to the next as the sum of pixels (heat) moves from one region to the next. Utilizing this principle, if a human moves from one region (where she was visible to the sensor) to the next (where she is invisible to the sensor due to an obstacle), the system can effectively know that although the human heat source became invisible within the space but the human has not left the field of view and therefore must be hidden behind an obstacle.

In alternative embodiments, visible light sensors and/or cameras may be used instead of or in combination with IR sensors, or a passive IR sensor may turn the output on while an IR grid array may be used to turn the output off. However, note that such solutions may require visible light to be present, consume additional computational and electrical power, and/or pose privacy issues. As will be appreciated, the techniques disclosed can be implemented so as to provide a digital output that may be used to control lights, HVAC systems, window blinds, surveillance cameras, or any other systems that may benefit from human presence detection, tracking, and positioning. For ease of description, however, examples are provided for controlling lighting systems. As will be further appreciated, the techniques disclosed may further provide an energy savings as output may be turned off as soon as the monitored space is vacated. Moreover, the techniques may provide a greater degree of immunity to false triggering, relative to the other systems that are incapable of distinguishing occupancy from baseline non-occupants (e.g., heating vent, fish tank, or other fixed or cyclical heat sources that may exist in a given space) or rely on movement to keep the output engaged. The techniques provided herein may further provide capability to log presence in areas that are not visible to an imaging sensor, or so-called blind spots.

### Human Presence Detection Examples

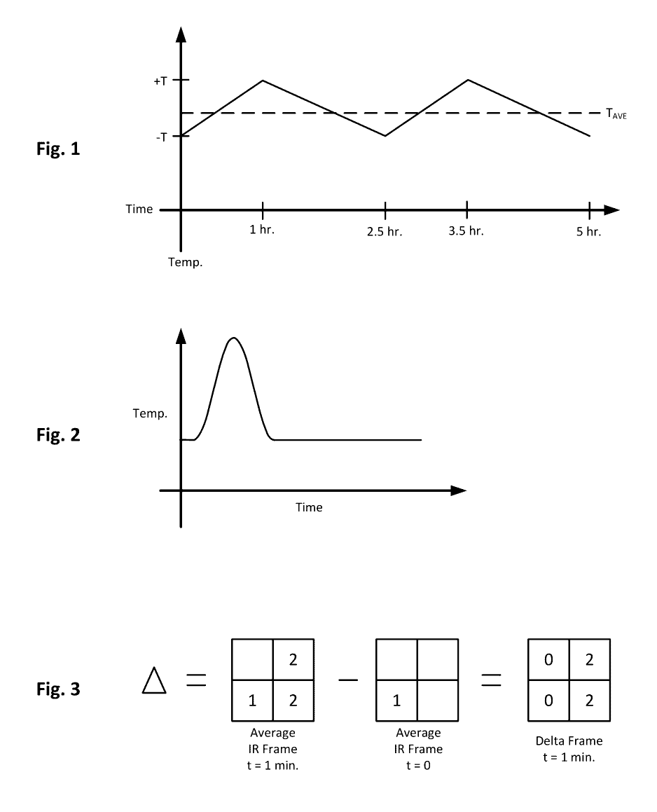

FIG. 1 is a graph of the temperature of a room over time for a cyclical heat source, such as an HVAC system. In such an example, when the room temperature reaches a lower threshold −T the heater turns on and increases the room temperature steadily up to an upper threshold value +T, at which point the heater turns off and the room slowly cools down to the lower threshold and the cycle repeats. As can be seen in this particular example scenario, the heater turns on at time t=0 and at the 2.5 hour mark, and turns off at the 1 hour and 3.5 hour marks when temperature +T is reached. While the temperature varies between +T and −T, the average temperature over time is a constant TAVE and the net temperature change from time t=0 to t=5 hours is zero.

FIG. 2 is a graph of the temperature of a room over time for a human entering and leaving the room. The human briefly enters the room, in this example, causing a spike in the local temperature. The thermal mass of a heat source may be computed based on the slope of change in temperature over time, as well as the magnitude of the heat change. As can be seen, the local temperature in this example increases more dramatically and has a steeper slope as compared to the cyclical heat source of FIG. 1 because the human body has a larger local heat signature.

In one embodiment of the present disclosure, IR sensor data is acquired as individual frames which may be expressed as F(w,h), in which w=frame width and y=frame height. The width and height of such frames may be determined by the digital resolution or pixel count in the IR sensor, in some embodiments. The acquired frames may be averaged over time for the purpose of noise filtering, as well as to calculate the multiple frame averages used to determine the delta value, in some embodiments. For ease of description, examples are provided below with a 2×2 pixel array; however, other IR image resolutions are possible as will be apparent in light of this disclosure. In some embodiments, equation (1) may be used to calculate the frame averages, where F represents the IR frame value at the i^{th} second, and F_{φ,t} represents the average IR frame over t seconds.

F_{φ,t}=1/t*Σᵢ₌₀^{t}Fᵢ(w,h) (1)

The delta frame, F_{Δ(m,n)}, may be calculated by subtracting two average IR frames averaged over different periods of time. For a static heat source, such as a person sitting at a desk for an extended period of time, the delta frame will be positive (or negative, depending on how the comparison is done) when the person enters the room. Subsequent delta frames remain zero while the person remains sitting at the desk (assuming the subsequent delta frames are computed based on average IR frames taken while the person is in the room). The delta frame will then transition to a negative (or positive, as the case may be) when the person leaves. The positive and negative transition points can be used to identify the entrance and departure times, respectively, of an occupant. A cycling heat source may be periodically detected and the delta value will change accordingly. However, as illustrated in FIG. 1, an average of the delta value over time will be zero. Thus, cycling heat sources (FIG. 1) can be effectively be masked out by using averaging, while non-cycling heat sources like an occupant (FIG. 2) can be identified for making an occupancy determination.

In one embodiment, the delta frame may be represented by equation (2), where F_{ave,m} is the average frame after time m, and F_{ave,n} is the average frame after time n. Assume that time m is after time n (e.g., m=n+x, where x is some positive real number representing a duration of time).

F_{Δ(m,n)}=F_{ave,m}−F_{ave,n} (2)

Such an example embodiment according to equation (2) is further illustrated in the Table 1 below.

TABLE 1
Example Delta Frame Computation

| Time | Delta Frame Compute | Delta Frame Value | Room Status |
|---|---|---|---|
| m + 1 | F_{ave,m+1}-F_{ave,m} | 0 | unoccupied |
| m + 2 | F_{ave,m+2}-F_{ave,m+1} | 0 | unoccupied |
| m + 3 | F_{ave,m+3}-F_{ave,m+2} | 1 | occupied |
| m + 4 | F_{ave,m+4}-F_{ave,m+3} | 0 | occupied |
| m + 5 | F_{ave,m+5}-F_{ave,m+4} | 0 | occupied |
| m + 6 | F_{ave,m+6}-F_{ave,m+5} | −1 | unoccupied |

The positive (1) and negative (−1) transition points mark the entry and departure, respectively, of the person. These positive and negative transition points effectively bookend the occupancy of the space being monitored. Note that the use of 0, 1, and −1 is not intended to imply integer values are required; rather, reasonable tolerances can be applied as appropriate. For instance, in some embodiments, the following tolerances apply: a delta frame value in the range of −v to +v may be considered a 0; anything greater than +v can be considered a 1; and anything less than −v can be considered a −1.

In another embodiment, note that the average frames used in computing a given delta frame can be selected to provide a consistently positive delta frame when a human occupant is in the room, rather than rely on positive and negative transition points bookending the occupancy. For example, in one embodiment, F_{ave,m} is the average frame when no human is in the room and is always used as the base comparison frame, while F_{ave,m+x} is some subsequent average frame where there may or may not be human presence.

TABLE 2
Example Delta Frame Computation

| Time | Delta Frame Compute | Delta Frame Value | Room Status |
|---|---|---|---|
| m + 1 | F_{ave, m+1}-F_{ave,m} | 0 | unoccupied |
| m + 2 | F_{ave, m+2}-F_{ave,m} | 0 | unoccupied |
| m + 3 | F_{ave, m+3}-F_{ave,m} | 1 | occupied |
| m + 4 | F_{ave, m+4}-F_{ave,m} | 1 | occupied |
| m + 5 | F_{ave, m+5}-F_{ave,m} | 1 | occupied |
| m + 6 | F_{ave, m+6}-F_{ave,m} | 0 | unoccupied |

In this example case, the delta frame is zero when there is no occupancy, and is non-zero (1 in this example case) when there is occupancy. Previous discussion with respect to non-integer values and tolerances equally applies here. Further note that the delta frame value can be converted to a binary value (e.g., in which occupied status is represented with a logical 1 and unoccupied status is represented with a logical 0).

FIG. 3 illustrates the calculation of a delta frame after one minute, according to an embodiment of the present disclosure. As can be seen, the IR sensor of this example embodiment includes four pixels and the room being scanned is divided into four sections. At time t=0, one corner of the room has a small heat source, such as a lamp, with a heat signature of 1. Note that the value of ‘1’ is intended to represent intensity of the heat detected. After one minute, two people having a larger heat signature of 2 have entered the right side of the room and the two pixels on the right of the IR frame have the value 2. These heat signature values are provided for illustrative purposes only and are not meant to reflect specific temperature values. Subtracting the average IR frame at one minute from the average IR frame at time zero, produces the delta frame at time t=1 minute. A sufficiently large value in a delta frame may indicate human presence in the room and cause the lights to be turned on, in some embodiments. In one specific example, a light turning on, a laptop fan activating, or cat entering a room does not create a large enough value in the delta frame to trigger the lighting system, while the heat signature of a human triggers the system and turns the lights on. The IR sensor may detect activity in isolated areas of a scanned space, and may also calculate a total activity magnitude value. Calculating a local activity may include, for example, scanning certain areas of space with one or more pixels of the IR sensor and calculating a local delta for each pixel or cluster of pixels. The total activity magnitude may be calculated, for example, by adding all the pixels in the delta frame at a given point in time. In one embodiment, the total activity magnitude V_{FΔ} may be represented by equation (3), where P_{Δ(x,y)} represents the value of pixel P at position (x,y) on the pixilated array at a given time, and V_{FΔ} represents the sum of all pixels in the delta frame at that time.

V_{FΔ}=Σ₀^{x-1}Σ₀^{y-1} (3)

Once activity within the room has been detected with the delta frame, a continued presence within the room may be determined by calculating a mask frame, in some embodiments. Such a mask frame may be calculated by integrating the delta frames over time. The mask frame may detect a stationary human presence by remaining a positive value even if no additional delta value is detected. Calculating a local presence may include, for example, scanning certain areas of space with different pixels and calculating a local mask frame value for each pixel or cluster of pixels. In such an embodiment, the pixels in an IR sensor array may be segmented into arrays or clusters, each cluster corresponding to, for example, a row of cubicles or a section of a conference room or other spaced being monitored. In some embodiments, an estimation of the number and location of people within a scanned area may be calculated, depending on the sensitivity and resolution of the IR sensor being used to capture IR frames. Furthermore, the location of a single person may be continuously tracked using the techniques described herein, in some embodiments. In one particular embodiment, a high resolution IR sensor may determine a human presence based on the number and shape of coherent pixels within the mask frame or the motion and speed of the pixels of the mask frame. Furthermore, a human entering or leaving the field of view of an IR sensor (e.g., behind a cubicle wall or other blind spot) may be detected and the system may be configured to account for such activity in the mask frame.

The mask frame F_{Mask} may be represented, in some embodiments, by equation (4), where F_{Δi} represents the delta frame at the i^{th} second, and β represents a diminishing factor used to clear the mask over time.

F_{Mask}=|Σᵢ₌₀^{t}F_{Δi}|*β (4)

While cyclical heat sources will negate themselves in the mask over time, it might be necessary to recalibrate or clear the mask frame in order to account for, for example, an added static heat source. In one example, an added static heat source could be a space heater, lamp, or desktop computer that is added to a room for a long period of time and is not a cyclical heat source. The diminishing factor accounts for these situations by clearing the mask at certain intervals. Under normal circumstances, a stationary human presence will not last more than a few hours in the same place at any one time, so the diminishing factor may be chosen such that stationary heat sources are cleared from the mask frame after a few hours. In one embodiment, β is a fixed number derived from the time which the mask gets cleared. Thus, in one embodiment, accumulating the delta values distinguishes human presence from cyclical heat sources while the diminishing factor distinguishes human presence from the background.

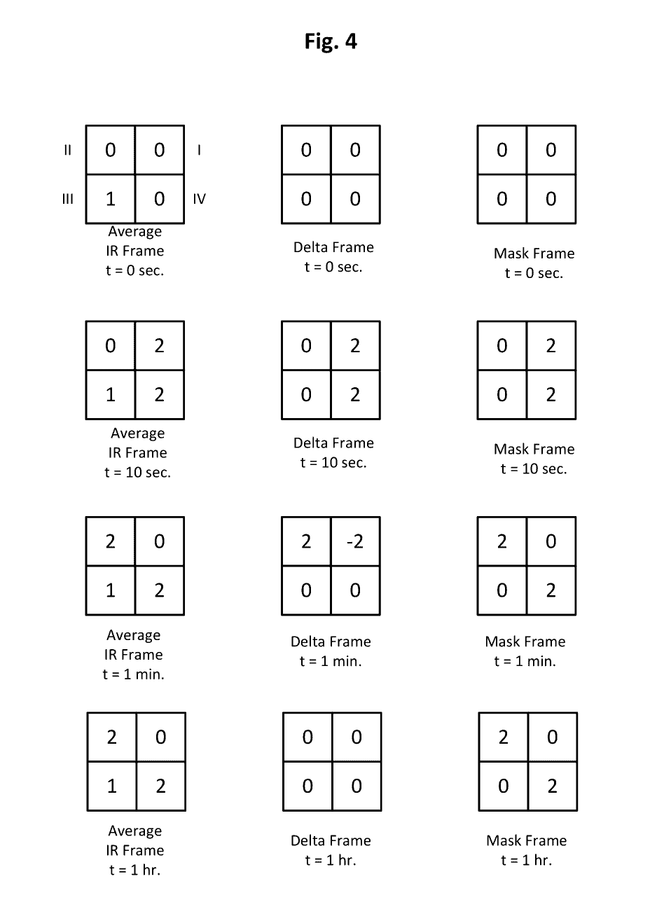

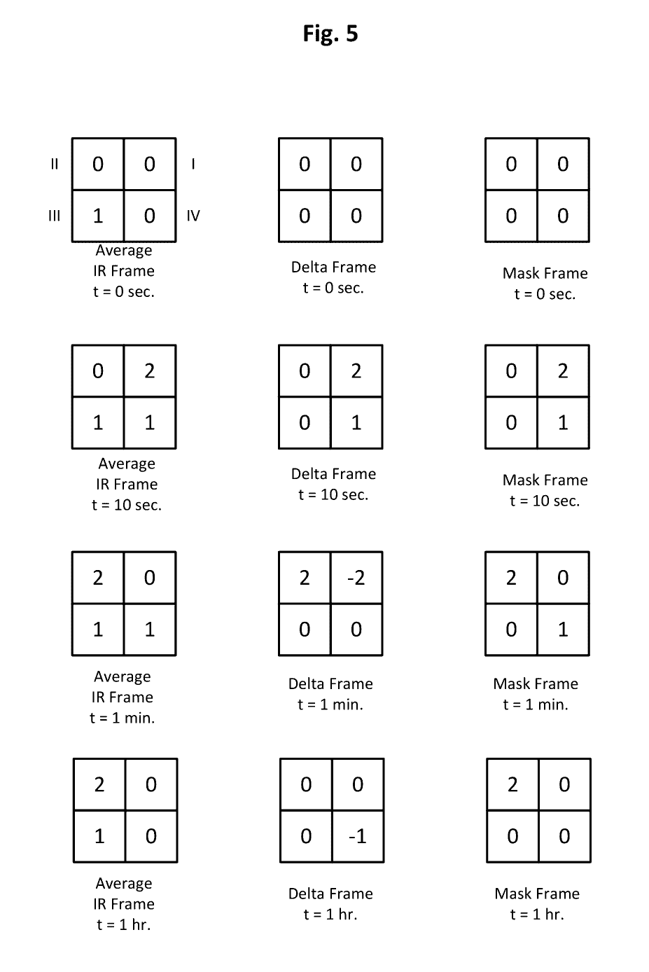

FIG. 4 shows the average IR frame, delta frame, and mask frame of a room at various time intervals, according to one embodiment of the present disclosure. In this particular example scenario, the IR sensor includes four pixels and the room being scanned is divided into four sections or quadrants. The sections/quadrants are only labeled on the first average IR frame, as I, II, III, and IV. At time t=0, the third quadrant (lower left corner) of the room has a small heat source, such as a lamp or desktop computer, with a heat signature of 1. This heat source is reflected by the value of 1 in the third quadrant in the first average IR frame at time t=0. The delta frame and the mask frame at t=0 are all zero in this embodiment. At time t=10 seconds, two people having a larger heat signature of 2 have entered the right side of the room and the first and fourth quadrants of the average IR frame now have the value 2. The first and fourth quadrants of both the delta frame and the mask frame at time t=10 seconds have a value of 2, reflecting the additional human presence. In one embodiment, the lighting system is configured to activate upon detecting an object with a heat signature of 2 or greater entering the room, so at t=10 seconds the lights in the room will turn on. At time t=1 minute, in this example embodiment, the person in the upper right corner of the room moves to another spot in the room (upper left corner), resulting in the second quadrant of the average IR frame now having a value of 2 and the first quadrant having a value of zero. The delta frame, in this example, now has a value of 2 in the second quadrant and −2 in the first quadrant at time t=1 minute (subtract the average IR frame at 10 seconds from the average IR frame at 1 minute). Because the mask frame is a summation of the delta frames (taken at 0, 10 seconds, and 1 minute), the mask frame now has a value of 2 in the second quadrant and zero in the first quadrant. After one hour, no additional activity has occurred in the room, in this example, and therefore the average IR frame at time t=1 hour is the same as at t=1 minute. The delta frame at time t=1 hour is zero because no change has been detected, however, the mask frame at time t=1 hour in this particular example still has a value of 2 in the second and fourth quadrants reflecting the stationary people in those parts of the room. While a standard motion sensing lighting system might turn off after not detecting motion for an hour, the lights remain on in this example embodiment because the mask frame monitors the stationary presence.

FIG. 5 shows the average IR frame, delta frame, and mask frame of a room at various time intervals, according to another embodiment of the present disclosure. In this particular example, the IR sensor includes four pixels and the room being scanned is divided into four sections or quadrants. Again, the sections/quadrants are only labeled on the first average IR frame, as I, II, III, and IV. At time t=0 one corner of the room has a small heat source, such as a lamp or desktop computer, with a heat signature of 1. This heat source is reflected by the value of 1 in the third quadrant in the first average IR frame at time t=0. The delta frame and the mask frame at t=0 are all zero in this embodiment. At time t=10 seconds, one person having a larger heat signature of 2 enters the right side of the room and the first quadrant of the average IR frame now has the value 2. Furthermore, a cyclical heating vent turns on and a heat signature of 1 is detected in the fourth quadrant of the average IR frame at time t=10 seconds. The first quadrant of the delta frame and the mask frame have a value of 2, while the fourth quadrant of the delta frame and the mask frame have a value of 1 at time t=10 seconds (subtract the average IR frame at 0 seconds from the average IR frame at 10 seconds to get the delta frame at 10 seconds, and sum the delta frames at 0 and 10 seconds to get the mask frame at 10 seconds). In one embodiment, the lighting system is configured to activate upon detecting an object with a heat signature of 2 or greater entering the room, so at t=10 seconds the lights in the room will turn on. At time t=1 minute, in this example embodiment, the person in the upper right corner of the room moves to another spot in the room (upper left corner), resulting in the second quadrant of the average IR frame now having a value of 2 and the first quadrant having a value of zero. The delta frame, in this example, now has a value of 2 in the second quadrant and −2 in the first quadrant at time t=1 minute (subtract the average IR frame at 10 seconds from the average IR frame at 1 minute to get the delta frame at 1 minute). Because the mask frame is a summation of the delta frames (at 0, 10 seconds, and 1 minute), the mask frame now has a value of 2 in the second quadrant and zero in the first quadrant. In this example, after one hour no additional human activity has occurred in the room. However, the local heating source detected in the fourth quadrant of the average IR frame at 10 seconds has now turned off causing the fourth quadrant of the delta frame to have a value of −1 at time t=1 hour (subtract the average IR frame at 1 minute from the average IR frame at 1 hour to get the delta frame at 1 hour). The cyclical heat source is then subtracted via the mask frame computation at time t=1 hour and the fourth quadrant of the mask frame has a value of zero (sum the delta frames at 0, 10 seconds, 1 minute, and 1 hour to get the mask frame at 1 hour). In this example embodiment, even though a decrease in heat is detected when the heating source in the fourth quadrant turns off, the lights will still remain on at time t=1 hour because the human presence in the second quadrant is still detected by the mask frame.

A mask magnitude may be calculated, in some embodiments, as the sum of all pixels in the mask frame F_{Mask} at a given point in time. The mask magnitude V_{FMask} may be represented, for example, by equation (5), where P_{Mask}(x,y) represents the value of pixel P at position (x,y) on the pixilated array.

V_{FMask}=Σ₀^{x-1}Σ₀^{y-1}P_{Mask}(x,y) (5)

In some embodiments, a digital mask frame may be calculated that represents the mask frame in a binary format. In one example, the digital mask may be used to easily identify human presence within the scanned space by filtering out any IR delta values in the mask that are below those typically created by a human presence. Specifically, if a human presence has a heat signature value of 2, for example, and a cat enters a room with a heat signature of 1, the mask frame may include a value of 1 in one section. However, since a heat signature of 1 is below the threshold for human presence, the digital mask may disregard that value, in some embodiments. In other embodiments the threshold may be calculated as the average pixel value, or any other value suitable for filtering out unwanted values in the mask frame. In one specific example, the digital mask frame F_{DMask} may be represented by equations (6) and (7), where P_{Mask}(x,y) represents the pixel value in the mask frame at position (x,y), P_{DMask}(x,y) represents the pixel value at position (x,y) of the digital mask frame, Threshold represents the average pixel value in the mask frame, and F_{DMask} represents the binary digital mask.

$$\begin{matrix}{F}_{DMask} = \{ \begin{matrix}{P}_{Mask} ( x , y ) > Threshold ; {P}_{DMask} ( x , y ) = 1 \\ {P}_{Mask} ( x , y ) < Threshold ; {P}_{DMask} ( x , y ) = 0\end{matrix} \} & ( 6 ) \\ Threshold = \frac{{\sum }_{0}^{x - 1} {\sum }_{0}^{y - 1} {F}_{Mask} ( x , y )}{\# pixels} & ( 7 )\end{matrix}$$

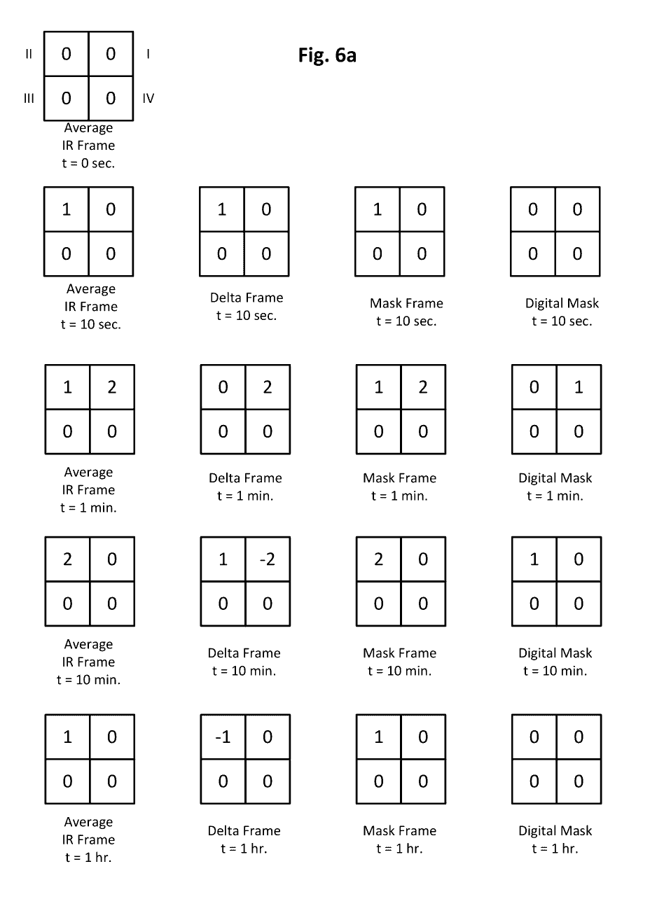

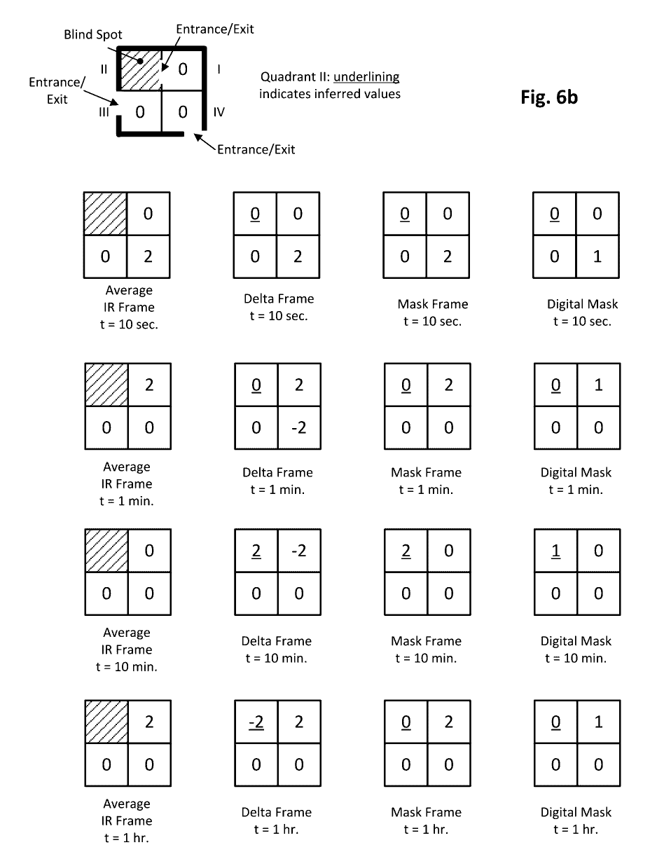

FIG. 6a shows the average IR frame, delta frame, mask frame, and digital mask frame of a room at various time intervals, according to one embodiment of the present disclosure. In this particular example, the IR sensor includes four pixels and the room being scanned is divided into four sections or quadrants. Again, the sections/quadrants are only labeled on the first average IR frame, as I, II, III, and IV. For ease of description, the digital mask frame in this particular example is calculated with a pixel threshold value of 1, such that any mask frame pixels with a heat signature value greater than 1 will have a non-zero value in the digital mask frame. At time t=0 no heat sources are detected in the scanned room, so the average IR frame is zero and the delta frame, mask frame, and digital mask frame will also be zero. Continuing with example scenario depicted, at time t=10 seconds, a heater turns on in one corner of the room, causing the second quadrant of the average IR frame to have a value of 1 at time t=10 seconds. The delta frame and the mask frame at time t=10 seconds both have a value of 1 in the second quadrant, in this example, representing the heating source in the corner of the room. The digital mask frame, however, still remains at zero because the heat signature of 1 from the heater is not greater than the threshold value for human presence. Because there are no non-zero values in the digital mask frame, the lights will remain off at time t=10 seconds, in this example. At time t=1 minute a person enters the upper right corner of the room, in this example, resulting in the first quadrant of the average IR frame, delta frame, and mask frame now having a value of 2. In addition, the digital mask now detects a heat signature of 2 in the mask frame, which is above the threshold value for human presence. Therefore, at time t=1 minute the digital mask has a value of 1 in the first quadrant, in this example, and the lights will turn on.

At time t=10 minutes, in this example, the person in the upper right corner moves in front of the heater in the upper left of the room, blocking the heat signature of the heater and resulting in the second quadrant of the average IR frame now having a value of 2 and the first quadrant having a value of zero. The delta frame, in this example, now has a value of 1 in the second quadrant and −2 in the first quadrant at time t=10 minutes. Because the mask frame is a summation of the previous delta frames, the mask frame at time t=10 minutes has a value of 2 in the second quadrant and zero in the first quadrant. The digital mask frame, in this example, still detects a heat signature of 2 in the mask frame, which is above the threshold value for human presence. Therefore, at time t=10 minutes, the digital mask frame has a value of 1 in the second quadrant, in this example, and the lights remain on. After one hour, the person leaves the room in this example, causing the average IR frame at time t=1 hour to have only a value of 1 in the second quadrant. The delta frame at time t=1 hour has a value of −1 in the second quadrant, in this example, representing the person having left the room and the heater remaining on. In this embodiment, the mask frame has a value of 1 in the second quadrant, which is not above the threshold heat signature for human presence, so the digital mask frame will have a value of zero in all sections and the lights will turn off at time t=1 hour. In some embodiments, depending on the value of the diminishing factor β, if the heater remains on in the upper left section of the room it may be cleared from the mask frame such that it will no longer contribute to the value of the mask frame.

In some embodiments, an inverse digital mask, F_{DMask}, may be calculated, which is a bitwise complement of the digital mask and may be used for background estimation. The background frame, F_{Back(n+1)}, at time “n+1” may be represented by equation (8), where F_{Back(n)} represents the previously calculated background frame, F_{Coeff} represents the frame of background weight coefficients, and F_{φ(n,t)} represents an average frame calculated from the frame buffer, where the average is of frames received over t seconds, n seconds ago. In some embodiments, the background frame begins at zero and slowly increases over time as the average frame increases. The inverse digital mask frame, F_{InvDMask} is the inverse compliment of the mask frame, such that the inverse digital mask will only have a positive value where the mask frame has a zero value, thus restricting the background frame to frame sections not included in the mask. Such a background frame may represent the IR signature of stationary or cyclical hot objects within the scanned area. In some embodiments, the coefficient frame is represented by equation (9), where P_{Mask}(x,y) is the value of pixel P in the mask frame at location (x,y).

$$\begin{matrix}{F}_{Back ( n + 1 )} = {F}_{Back ( n )} + [ \frac{{F}_{φ ( n , t )} - {F}_{Back ( n )}}{{F}_{Coeff}} ] * {F}_{InvDMask} & ( 8 ) \\ {F}_{Coeff} = \{ \begin{matrix}{P}_{Mask} ( x , y ) > MaskThreshold ; {F}_{Coeff} = 1 \\ {P}_{Mask} ( x , y ) < MaskThreshold ; {F}_{Coeff} = 1 + {P}_{Mask}^{2}\end{matrix} \} & ( 9 )\end{matrix}$$

In some embodiments, a stationary human presence may be detected using the background frame, in which the background frame is subtracted from a current average of IR frames. Background estimation requires more IR image processing as compared to detecting stationary human presence from the mask frame; however, increased accuracy may be achieved in some embodiments by subtracting the background frame from a current average of IR frames. Such a technique receives IR sensor data and removes any data relating to background objects and heat sources, effectively distinguishing between a stationary human presence and any background IR heat that may be present in a room. The presence frame represents the final presence calculation after subtracting the background frame from a short term average. In one embodiment, the presence frame F_{Presence}, may be represented by equation (10).

F_{Presence}=|F_{φ(n sec)}−F_{Back(n)}| (10)

In some embodiments, a local presence or general presence may be calculated. Calculating a local presence may include, for example, scanning certain areas of space with different pixels and calculating a local presence value for each pixel or cluster of pixels. In other embodiments, a total presence value may be calculated using equation (11), where P_{Presence}(x,y) represents the value of pixel P at position (x,y) on the pixilated array, and V_{FPresence} represents the sum of all pixels in the presence frame.

V_{FPresence}=Σ₀^{x-y}Σ₀^{y-1}P_{Presence}(x,y)

FIG. 6b shows the average IR frame, delta frame, mask frame, and digital mask frame of a room at various time intervals, according to another embodiment of the present disclosure. In this particular example, the IR sensor includes three pixels and the room being scanned is divided into four sections or quadrants. Again, the sections/quadrants are only labeled on the first average IR frame, as I, II, III, and IV. However, in this example case, the room configuration is such that the second quadrant includes a blind spot that cannot be seen by any active pixels of the sensor. Note that there may actually be a fourth pixel, but that pixel is obscured from seeing into the second quadrant; alternatively, there may simply be no pixel associated with the second quadrant. Further note that the first quadrant includes the only entrance to (and exit from) the blind spot area of the second quadrant, such that any person passing into or out of the blind spot must pass through the first quadrant. Further note the entrance/exits of the room in the third and fourth quadrants. These various room features are not shown in the other 2-by-2 grids of FIG. 6b to avoid visual clutter, but can be readily envisioned.

As will be appreciated, the previous relevant discussion with respect to FIGS. 4, 5, and 6a is equally applicable here, so only differences will be discussed here. For purposes of this example illustration, assume each of the average IR frame, delta frame, mask frame, and digital mask frame are zero prior to time t=10 seconds. At time t=10 seconds a person enters the room via the entrance in the fourth quadrant, causing the fourth quadrant of the average IR frame to have a value of 2 at time t=10 seconds. Accordingly, the delta frame and the mask frame at time t=10 seconds both have a value of 2 in the fourth quadrant, and the digital mask frame transitions from a 0 to a 1, because the heat signature of 2 from the person is greater than the threshold value for human presence. Because there is a non-zero value in the digital mask frame, the control system will turn on the lights at time t=10 seconds (or command some other occupancy-based function).

At time t=1 minute the person moves from the fourth quadrant to the first quadrant of the room, resulting in the first quadrant of the average IR frame, delta frame, and mask frame now having a value of 2. In addition, the digital mask now detects a heat signature of 2 in the mask frame at the first quadrant. Therefore, at time t=1 minute the digital mask has a value of 1 in the first quadrant, and the lights remain on (or turn on in the first quadrant and turn off in the fourth quadrant, or some other suitable light control response to the detected movement). Further note that the value of the first quadrant of the delta frame transitions from 2 to −2 (based on subtraction of the average IR frame at 10 seconds from average IR frame at 1 minute). Further note that the value of the first quadrant of the mask frame transitions from 2 to 0 (based on addition of available delta frames at 1 minute). Further note that the value of the second quadrant corresponding to the blind spot in each of the delta, mask, and digital mask frames can be inferred to have a value of 0. The inferred nature of this second quadrant value is indicated with underlining.

At time t=10 minutes, in this example scenario, the person in the first quadrant moves into the blind spot of the room in the second quadrant. At this point, an inference can be made that the person is now in the blind spot of the room, because there is no sensor-based evidence that the person has moved from the first quadrant into either of the third or fourth quadrants. Thus, it is reasonable to infer or otherwise assume that the user moved into the blind spot of the second quadrant. To this end, even though the second quadrant of the average IR frame has a value of zero or is otherwise not indicative of human occupancy, the second quadrant of the delta frame can be affirmatively set (via a processor action, for example) to a value of 2 at time t=10 minutes, based on the reasonable inference noted. Note the 2 in the second quadrant of the delta frame is underlined, to indicate it is an inferred value based on the known heat signature value detected in the first quadrant and that presumably moved into the second quadrant blind spot. In addition, the other values of the delta frame in the first, third, and fourth quadrants can be set as previously explained (by subtracting the average IR frame at time t=1 minute from the average IR frame at time t=10 minutes). Because the mask frame is a summation of the previous delta frames, the mask frame at time t=10 minutes has a value of 2 in the second quadrant and zero in the first quadrant. In addition, the digital mask frame still detects a heat signature of 2 in the mask frame, which is above the threshold value for human presence. Therefore, at time t=10 minutes, the digital mask frame has a value of 1 in the second quadrant, and the lights remain on (even though the person occupying the room is not directly visible by the IR sensors). As will be further appreciated, note that the second quadrant value in each of the mask frame and digital mask frame is underlined to indicate that value is based on an inferred value from the delta frames.

After one hour, the person leaves the blind spot in the second quadrant and reenters the first quadrant, causing the average IR frame at time t=1 hour to have a value of 2 in the first quadrant. Thus, the delta frame at time t=1 hour has a measured 2 in the first quadrant, and an inferred value of −2 in the second quadrant. Continuing with the example, the mask frame now has a value of 0 in the second quadrant and a value of 2 in the first quadrant, and the digital mask frame has a value of 0 in the second quadrant and a value of 1 in the first quadrant. Thus, the lights remain on. Should the user now leave the room through either of the exits in the third and fourth quadrants, that movement can be tracked as provided herein, and the lights can be switched off once the mask frame quadrants are all 0, or once the digital mask frame quadrants are all 0, as the case may be.

### METHODOLOGY

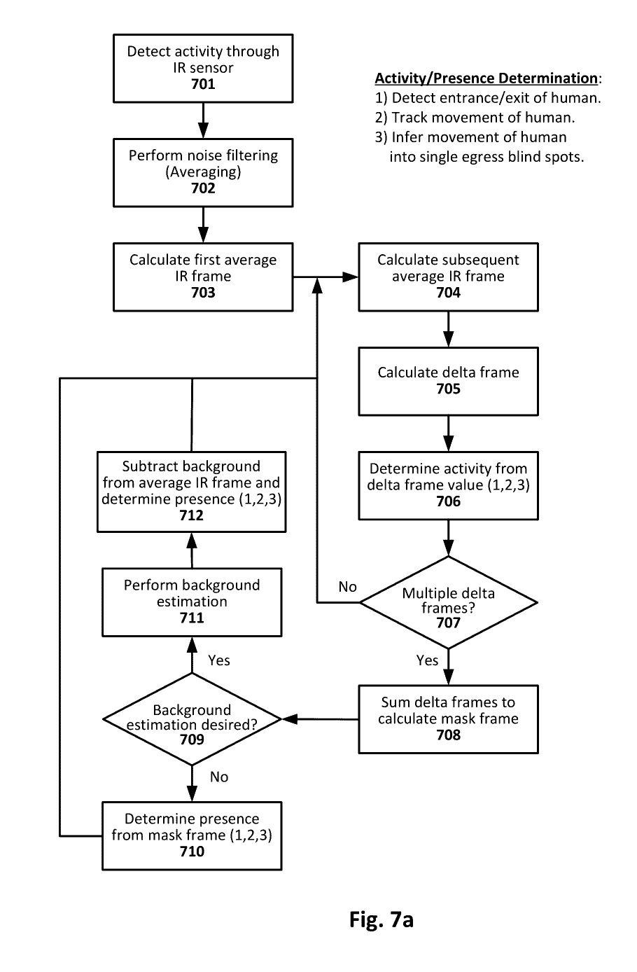

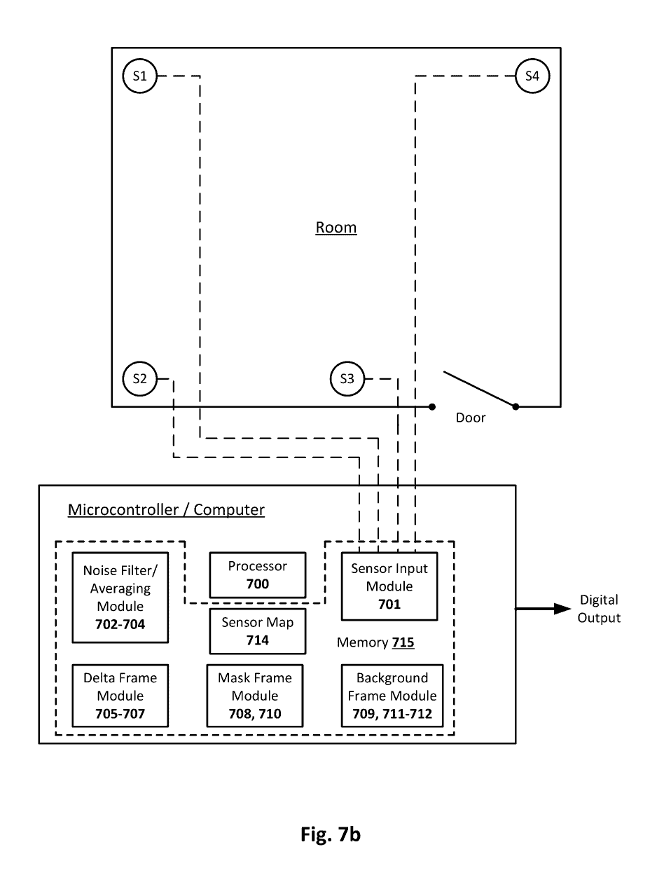

FIG. 7a illustrates a method for detecting stationary human presence, according to an embodiment of the present disclosure. The method may begin with detecting 701 activity through an IR sensor. In some embodiments, the IR sensor includes an array of IR pixels capable of detecting hot objects entering and moving within the scanned space. The method may continue with performing 702 noise filtering, which includes averaging the IR frames detected by the IR sensor. The method may continue with calculating 703 a first average frame. The first average frame may include an average of IR frames over a first period of time, for example, one second. Other time periods are possible and the average frames described herein may be calculated over any number of time increments. The method may continue with calculating 704 a subsequent average IR frame. Once at least two average IR frames have been calculated, the method may continue with calculating 705 a delta frame. The delta frame may be calculated, for example, by subtracting the subsequent average IR frame from the first average IR frame. In some embodiments, several average frames may be calculated at various time increments, and a delta frame may be calculated by subtracting any average IR frame from the previous average IR frame.

The method may continue with determining 706 human activity from the delta frame value. As can be see, the activity may include one or more of: (1) detecting entrance or exit of a human; (2) tracking movement of a human; and (3) inferring movement of a human into blind spots that don't have a hidden exit (such as the second quadrant of the example room shown in FIG. 6b, or some other configuration where each exit from the blind spot is effectively monitored by a given IR sensor). In some embodiments, the lighting system may be configured to activate upon detecting a delta value associated with the heat signature of a person entering a room (generally referred to herein as a heat signature difference). In such embodiments, any delta value less than that caused by a human presence, such as a pet or heating vent will not trigger the lighting system. The method may continue with determining 707 whether multiple delta frames have been calculated. If multiple delta frames have not been calculated, the method may continue with calculating 704 another subsequent average IR frame as well as calculating 705 another delta frame. If multiple delta frames have been calculated, the method may continue with summing 708 the delta frames to calculate a mask frame.

After the mask frame has been calculated, the method may continue with determining 709 whether background estimation is desired. If background estimation is not desired, the method may continue with determining 710 human presence based on the value of the mask frame. In some embodiments, determining human presence from the mask frame may include calculating a digital mask frame. If background estimation is desired, the method may continue with performing background estimation 711 by calculating a background frame. The method may continue with subtracting 712 the background frame from the current average frame in order to determine human presence. In some embodiments, performing background estimation and subtracting the background frame from the average frame may provide additional accuracy for human presence detection. As will be further appreciated in light of this disclosure, determining human presence at 710 and/or 712 may include one or more of the following activities: (1) detecting entrance or exit of a human; (2) tracking movement of a human; and (3) inferring movement of a human into egress-monitored blind spots (such as the second quadrant of the example room shown in FIG. 6b).

FIG. 7b illustrates an example system that can carry out the method of FIG. 7a, according to an embodiment of the present disclosure. As can be seen, the system includes a microcontroller or computer configured to detect human presence in a room using data collected from an IR sensor array. In this particular example embodiment, the microcontroller or computer that is programmed or otherwise configured with a number of executable or otherwise controllable modules, including a sensor input module, noise filtering/averaging module, delta frame module, mask frame module, and background frame module. The various functional modules are stored in memory 715 and executable by processor 700. In addition, a sensor map 714 is provided in the memory, which associates specific pixels of the sensor array with specific regions of the area being monitored. In this way, detection signals from the sensor array can be correlated to specific regions of the area being monitored, for purposes of tracking the occupant. This is particularly useful, for instance, to identify when an occupant has disappeared into a blind spot of the area being monitored, as will be appreciated in light of this disclosure. Such tracking allows reasonable inferences to be made. This sensor map 714 can be generated, for instance, during commissioning of the lighting system by the installer. In such cases, the installer can purposefully place the sensors of the IR array in effort to either eliminate blind spot regions or otherwise isolate blind spot regions so that entry to and exit from those blind spot regions can be monitored by monitoring activity in neighboring non-blind spot regions. As will be appreciated, the various functional modules 701-712 and sensor map 714 may vary from one embodiment to the next, as may the degree of integration. For instance, in some embodiments, the delta frame, mask frame, and background frame modules may be implemented in a single module that provides the same overall functionality. Likewise, the sensor map 714 may be integrated with the sensor input module 701. To this end, note that the example system architecture shown is provided for purposes of discussion and is not intended to limit the present disclosure to any particular configuration; numerous other configurations will be apparent in light of this disclosure.

The sensor input module is connected to a number of IR sensors S1-4, located within a room having a single entrance door, in this particular example. Further recall that the sensors can be purposefully arranged during commissioning of the system to either eliminate blind spots or limit blind spots to the type where inferential determinations of blind spot occupancy can be made based on monitored non-blind spot areas neighboring the blind spot so that entering and exiting with respect to the blind spot can be tracked, as provided herein (sensor map 714). With respect to making inferential determinations, and according to some embodiments, note that every exit from a given blind spot can be monitored by an IR sensor (or other sensor type, for that matter), such that if a person moves into and then out of that blind spot at least one sensor effectively monitoring the entrance/exit of that blind spot will detect or otherwise signal that departure. Further note that, in some embodiments, an exit from a blind spot that is not monitored by an IR sensor can still be allowed. In some such cases, other sensor types can be used to assess the occupancy of the blind spot at the hidden exit. For instance, a motion detector can be used to monitor an external exit from the blind spot and signal a person's departure from the blind spot. Alternatively, an LED beam/detector arrangement, such as a system similar to a garage door detection system having a LED beam projected across the garage opening that detects when the beam is broken, could be used to signal departure from the blind spot. In still other embodiments, a sound sensor can monitor the blind spot and signal perceived departure (e.g., based on silence or an outer door closing sound). In still other embodiments, the blind spot may be completely unmonitored, and an exit to the external area (outside the monitored space) can be signaled after a fixed period of time (e.g., 1 hour, or two hours, or three hours, etc). Any sensor signals generated, whether IR or otherwise, can be provided to the sensor input module such that determinations as to occupancy and tracking can be made.

The microcontroller or computer may be any suitable microcontroller (e.g., an Arduino microcontroller or other suitable processing environment or computing system), and may include one or more co-processors or controllers. In the embodiment shown, a processor 700 is provided. The functional modules can be implemented, for example, in any suitable programming language (e.g., C, C++, objective C, JavaScript, custom or proprietary instruction sets, etc.), and encoded on one or more non-transitory processor readable mediums, that when executed or otherwise controlled by the microcontroller (and/or co-processors, such as processor 700), carries out the human presence detection techniques as variously described herein. In the example provided herein, human presence detection may be achieved using various modules within a single microcontroller/computer, however, as discussed above image processing and human presence detection may alternatively be performed on two or more separate computers, microcontrollers, or processors that collectively communicate with each other and the IR sensors, in other embodiments. When describing the various example modules shown in FIG. 7b, reference will be made to corresponding functions previously discussed with reference to FIG. 7a.

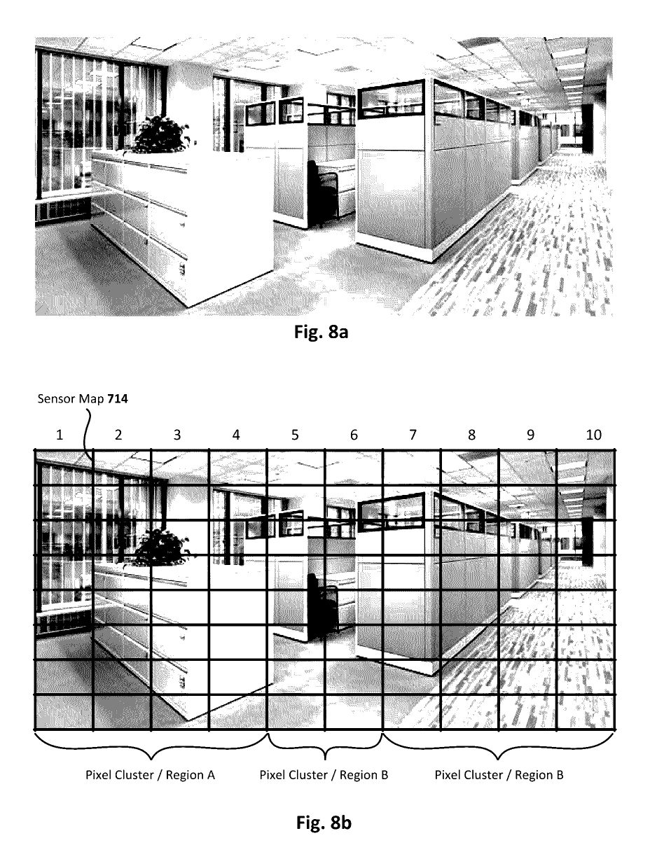

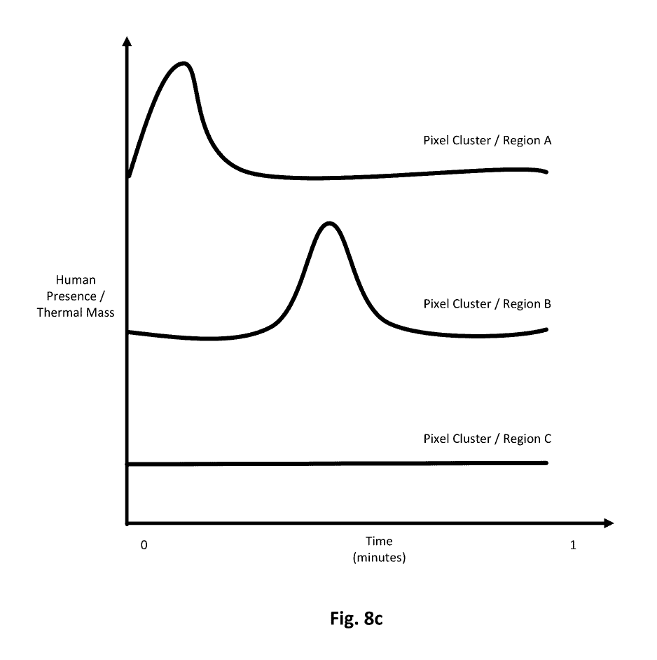

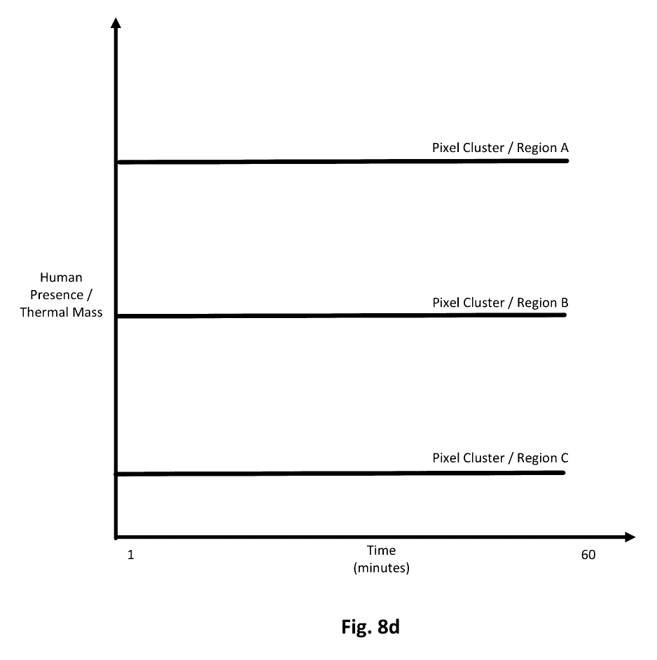

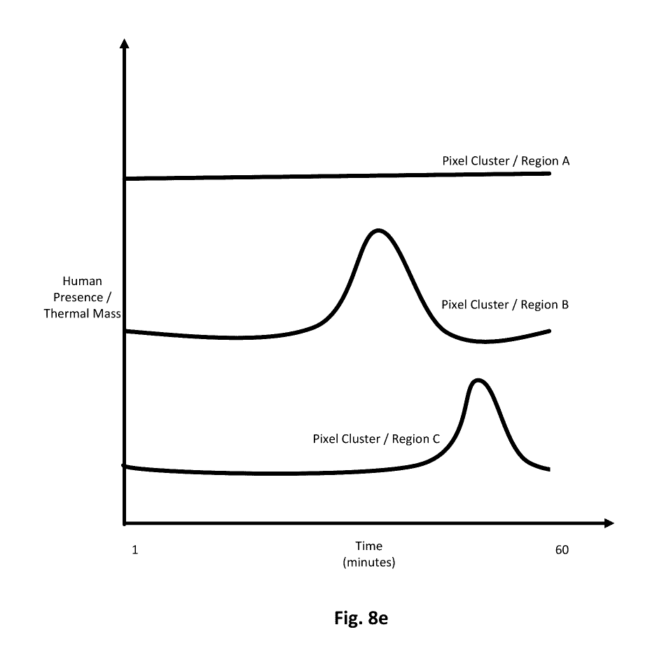

With further reference to the example embodiment shown in FIG. 7b, the sensor input module is programmed or otherwise configured to receive input from the IR sensors S1-4, located at various positions within the room and detects 701 activity through the IR sensors. In some cases it may be desirable to position an IR sensor on the ceiling and at least two adjacent walls in order to effectively scan a room so as to avoid any blind spots or otherwise leave only blind spots that have a single point of egress that can be monitored by at least one of the sensors S1-4. As previously explained, a sensor map 714 of commissioned sensors can be stored in a memory or otherwise made accessible to the inference determination process, as will be further explained with reference to the example use case of FIG. 8b. The noise filtering/averaging module is configured to perform noise filtering 702, and calculate a number of average frames 703-704, in some embodiments. The delta frame module, in this example, is configured to calculate 705 a delta frame, determine 706 activity within the room based on the value of the delta frame, and determine 707 the number of delta frames calculated. The mask frame module is configured to sum 708 the delta frames to calculate a mask frame value, and determine 710 presence from a mask frame value, in some embodiments. In other embodiments, the mask frame module may also be programmed or otherwise configured to calculate a digital mask as an alternative technique for determining human presence. The background frame module may be configured to determine 709 whether background estimation is desired, perform 711 background estimation, and subtract 712 a background frame from an average frame to determine human presence, in some embodiments. As previously explained, the activity determined at 706 or presence determined at 710 or 712 may include one or more of: (1) detecting entrance or exit of a human; (2) tracking movement of a human; and (3) inferring movement of a human into blind spots. In this particular example, the microcontroller/computer further produces a digital output based on the human presence determination, and this digital output may be used to control various systems including, for example lighting, surveillance, HVAC, safety, and/or alarm systems.

### Example Use Case

FIG. 8a illustrates an example field of view of an IR grid array sensor, in accordance with an embodiment of the present disclosure. As can be seen, in this example scenario the FOV includes an office setting that generally includes a credenza, a cubicle, and a hallway. As will be appreciated in light of this disclosure, the FOV can be correlated to a sensor map where one or more pixels of a given sensor array are associated with a specific region of the area being monitored. For instance, and as shown by the sensor map 714 of FIG. 8b, the sensor grid array is broken into three regions or pixel groups: regions A, B, and C. Region A of the sensor map 714 corresponds to the credenza area, region B of the sensor map 714 corresponds to the cubicle entrance, and region C of the sensor map 714 corresponds to the hallway. As can further be seen, region A includes columns 1 through 4 of the IR grid array, region B includes columns 5 and 6 of the IR grid array, and region C includes columns 7 through 10 of the IR grid array. As previously explained, this sensor map 714 can be stored in memory of the lighting controller. FIGS. 8c through 8e illustrate example sensor detection signals from pixel regions representing regions A, B, and C of the sensor map 714, in accordance with an embodiment of the present disclosure. The detection signals are received over a period of time covering the occupancy, as can be seen.

In more detail, FIG. 8c shows human presence is detected in region A of the sensor map 714 shortly after t=0 followed by detection in region B of the sensor map 714 at around 20 or so seconds. The processor 700 can correlate these specific detection signals from the array to the regions of the sensor map 714 and therefore know that an occupant entered the credenza area from the left and then passed into the area in front of the cubicle. Then, as shown in FIG. 8d, the sensed thermal mass/occupant seemingly disappears as the occupant enters the blind spot within the cubicle. Note that no further activity was detected in the hallway of region C of the sensor map 714, and no further activity was detected in the credenza area B of the sensor map 714, so the processor 700 can infer that the occupant is in the blind spot of the cubicle area. Thus, even though the detection signals of FIG. 8d show no thermal mass/occupancy (and therefore no activity), the system inferentially knows that an occupant is in the area, so that lighting (or some other controlled feature) remains on or otherwise engaged. However, at around 45 minutes or so from t=0, the occupant emerges from the cubicle which presents as a detection signal in region B of the sensor map 714 as shown in FIG. 8e. The occupant stays in the location briefly (to get a file or speak with a colleague), and then proceeds down the hallway at around 50 minutes, which presents as a detection signal in region C of the sensor map 714 as shown in FIG. 8e. Thus, the processor 700 now knows that the occupant has left the space, and the lights can be turned off. Numerous such use cases will be apparent in light of this disclosure.

Numerous embodiments will be apparent, and features described herein can be combined in any number of configurations.

Example 1 is a presence detection system. The system includes an infrared (IR) sensor array configured to scan an area and capture a plurality of IR frames; and a processor operatively coupled to the IR sensor array, in which the processor is configured to: receive the plurality of IR frames; detect human presence and lack of human presence in the area based on heat signature differences indicated in the plurality of IR frames; and infer human presence in a known blind spot of the area based on detected human presence in non-blind spots neighboring the known blind spot so that entering and exiting with respect to the known blind spot is tracked.

Example 2 includes the subject matter of Example 1, in which the processor is further configured to: calculate a plurality of average IR frames over various time intervals, calculate a plurality of delta frames by subtracting a previously calculated average IR frame from a current average IR frame, and calculate a mask frame by summing the plurality of delta frames; and determine whether a human presence exists in the area based on a value of the mask frame multiplied by a diminishing factor.

Example 3 includes the subject matter of Example 2, in which the processor is further configured to compute a digital mask, the digital mask representing the mask frame in a binary format, in which a human presence is determined based on a value of the digital mask.

Example 4 includes the subject matter of any of Examples 1 through 3, and further includes a memory storing a sensor map that correlates a first group of one or more pixels of the sensor array to a first region of the area and second group of one or more pixels of the sensor array to a second region of the area, in which the processor is further configured to track the location of a human presence within the area based on the sensor map.

Example 5 includes the subject matter of any of Examples 1 through 4, in which the processor infers human presence in the known blind spot of the area by receiving data indicating presence of an occupant in a first region of the area, subsequently receiving data indicating no occupant being detected in the first region and no occupant being detected in a second region of the area neighboring the first region, in which the known blind spot is in the second region, and determining that the occupant moved from the first region to the known blind spot in the second region based on no occupant being detected in either of the first or second regions.

Example 6 includes the subject matter of Example 5, in which the processor correlates the data indicating presence of the occupant to the first region of the area using a sensor map stored in memory accessible to the processor. In some cases, the sensor map is stored, for instance, local to the processor. In other case, the sensor map is stored remote from the processor, such as in the cloud or on a remote server accessible by the processor via a communication network (e.g., the Internet or some other wide area network, or a combination of local area network and wide area network).

Example 7 includes the subject matter of any of Examples 1 through 6, in which the processor is further configured to provide an output indicating a human presence exists, in which the output is used to control at least one of an HVAC, a lighting device, window blinds, a surveillance system, and a security system.

Example 8 includes a method of detecting human occupancy, the method including: obtaining a plurality of IR frames of a given area based on data captured by an IR sensor, calculating, by a processor, a plurality of average IR frames over various time intervals from the plurality of IR frames, calculating, by the processor, a plurality of delta frames, in which each delta frame is the difference between a current average IR frame and a previously calculated average IR frame, calculating, by the processor, a mask frame, in which the mask frame is a summation of the plurality of delta frames, and determining whether a human presence exists in the area based on the value of the mask frame, in which the determining includes inferring human presence in a known blind spot of the area based on detected human presence in non-blind spots neighboring the known blind spot so that entering and exiting with respect to the known blind spot is tracked.

Example 9 includes the subject matter of Example 8, in which detecting a plurality of IR frames further includes combining IR sensor data with camera data.

Example 10 includes the subject matter of Example 8 or 9, and further includes computing a digital mask, in which the digital mask represents the mask frame in a binary format; and determining whether a stationary human presence exists based on the value of the digital mask.

Example 11 includes the subject matter of Example 10, and further includes calculating a background frame, in which the background frame represents IR sensor data not represented in the digital mask; and determining a human presence by subtracting the background frame from a current average IR frame.

Example 12 includes the subject matter of any of Examples 8 through 11, and further includes at least one of: determining activity within the area based on the value of the plurality of delta frames; tracking the position of a human presence based on the value of the mask frame; and estimating the number and location of human presence within a scanned area based on the value of the mask frame.

Example 13 includes the subject matter of any of Examples 8 through 12, in which a memory stores a sensor map that correlates a first group of one or more pixels of the sensor array to a first region of the area and second group of one or more pixels of the sensor array to a second region of the area, the method further including tracking the location of a human presence within the area based on the sensor map.

Example 14 includes the subject matter of any of Examples 8 through 13, in which inferring human presence in the known blind spot of the area includes: receiving data indicating presence of an occupant in a first region of the area, subsequently receiving data indicating no occupant being detected in the first region and no occupant being detected in a second region of the area neighboring the first region, in which the known blind spot is in the second region, and determining, by the processor, that the occupant moved from the first region to the known blind spot in the second region based on no occupant being detected in either of the first or second regions.

Example 15 includes the subject matter of Example 14, and further including correlating the data indicating presence of the occupant to the first region of the area using a sensor map stored in a memory accessible to the processor.

Example 16 includes the subject matter of any of Examples 8 through 15, and further includes providing an output indicating a human presence exists, in which the output is used to control at least one of an HVAC, a lighting device, window blinds, a surveillance system, and a security system.

Example 17 is a computer program product including one or more non-transitory processor readable mediums encoded with instructions that when executed by one or more processors cause a process to be carried out for detecting human occupancy, the process including: receiving data representative of a plurality of IR frames captured by an infrared (IR) sensor array configured to scan an area, detecting human presence and lack of human presence in the area based on heat signature differences indicated in the IR frames, and inferring human presence in a known blind spot of the area based on detected human presence in non-blind spots neighboring the known blind spot so that entering and exiting with respect to the known blind spot is tracked. The non-transitory processor readable medium(s) can be any suitable memory, such as ROM, RAM, disc, thumb drive, server, hard disk, solid state drive, etc.

Example 18 includes the subject matter of Example 17, the process further including: provide an output indicating a human presence exists, in which the output is used to control at least one of an HVAC, a lighting device, window blinds, a surveillance system, and a security system.

Example 19 includes the subject matter of Example 17 or 18, in which the process further includes: calculating a plurality of average IR frames over various time intervals, calculating a plurality of delta frames by subtracting a previously calculated average IR frame from a current average IR frame, calculating a mask frame by summing the plurality of delta frames, and tracking a position of a human presence based on a value of the mask frame.

Example 20 includes the subject matter of Example 19, in which the process further includes determining activity within the area based on the value of the plurality of delta frames.

Example 21 includes the subject matter of any of Examples 17 through 20, in which a sensor map correlates a first group of one or more pixels of the sensor array to a first region of the area and a second group of one or more pixels of the sensor array to a second region of the area, the process further including tracking the location of a human presence within the area based on the sensor map.

Example 22 includes the subject matter of any of Examples 17 through 21, in which inferring human presence in the known blind spot of the area includes: receiving data indicating presence of an occupant in a first region of the area, subsequently receiving data indicating no occupant being detected in the first region and no occupant being detected in a second region of the area neighboring the first region, in which the known blind spot is in the second region, and determining that the occupant moved from the first region to the known blind spot in the second region based on no occupant being detected in either of the first or second regions.

Example 23 includes the subject matter of Example 22, in which the process further includes correlating the data indicating presence of an occupant to the first region of the area using a sensor map stored in a memory accessible to the processor. Again, note the memory may be local to the processor or remote to the processor as previously explained.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. A presence detection system comprising:
an infrared (IR) sensor array configured to scan an area and capture a plurality of IR frames; and
a processor operatively coupled to the IR sensor array, wherein the processor is configured to:
receive the plurality of IR frames;
detect human presence and lack of human presence in the area based on heat signature differences indicated in the plurality of IR frames; and
infer human presence in a known blind spot of the area based on detected human presence in non-blind spots neighboring the known blind spot so that entering and exiting with respect to the known blind spot is tracked.

2. The system of claim 1, wherein the processor is further configured to:
calculate a plurality of average IR frames over various time intervals;
calculate a plurality of delta frames by subtracting a previously calculated average IR frame from a current average IR frame;
calculate a mask frame by summing the plurality of delta frames; and
determine whether a human presence exists in the area based on a value of the mask frame multiplied by a diminishing factor.

3. The system of claim 2, wherein the processor is further configured to:
compute a digital mask, the digital mask representing the mask frame in a binary format, wherein a human presence is determined based on a value of the digital mask.

4. The system of claim 1, the system further comprising:
a memory storing a sensor map that correlates a first group of one or more pixels of the sensor array to a first region of the area and a second group of one or more pixels of the sensor array to a second region of the area;
wherein the processor is further configured to track a location of a human presence within the area based on the sensor map.

5. The system of claim 1, wherein the processor infers human presence in the known blind spot of the area by:
receiving data indicating presence of an occupant in a first region of the area;
subsequently receiving data indicating no occupant being detected in the first region and no occupant being detected in a second region of the area neighboring the first region, wherein the known blind spot is in the second region; and
determining that the occupant moved from the first region to the known blind spot in the second region based on no occupant being detected in either of the first or second regions.

6. The system of claim 5, wherein the processor correlates the data indicating presence of the occupant to the first region of the area using a sensor map stored in a memory accessible to the processor.

7. The system of claim 1, wherein the processor is further configured to provide an output indicating a human presence exists, wherein the output is used to control at least one of an HVAC, a lighting device, window blinds, a surveillance system, and a security system.

8. A method of detecting human occupancy, the method comprising:
obtaining a plurality of IR frames of a given area based on data captured by an IR sensor;
calculating, by a processor, a plurality of average IR frames over various time intervals from the plurality of IR frames;
calculating, by the processor, a plurality of delta frames, wherein each delta frame is the difference between a current average IR frame and a previously calculated average IR frame;
calculating, by the processor, a mask frame, wherein the mask frame is a summation of the plurality of delta frames; and
determining whether a human presence exists in the area based on the value of the mask frame, wherein the determining includes inferring human presence in a known blind spot of the area based on detected human presence in non-blind spots neighboring the known blind spot so that entering and exiting with respect to the known blind spot is tracked.

9. The method of claim 8, wherein detecting a plurality of IR frames further comprises combining IR sensor data with camera data.

10. The method of claim 8, the method further comprising:
computing a digital mask, wherein the digital mask represents the mask frame in a binary format; and
determining whether a stationary human presence exists based on the value of the digital mask.

11. The method of claim 10, the method further comprising:
calculating a background frame, wherein the background frame represents IR sensor data not represented in the digital mask; and
determining a human presence by subtracting the background frame from a current average IR frame.

12. The method of claim 8, the method further comprising at least one of:
determining activity within the area based on the value of the plurality of delta frames;
tracking the position of a human presence based on the value of the mask frame; and
estimating a number and location of human presence within the area based on the value of the mask frame.

13. The method of claim 8, wherein a memory stores a sensor map that correlates a first group of one or more pixels of the sensor array to a first region of the area and a second group of one or more pixels of the sensor array to a second region of the area, the method further comprising:
tracking the location of a human presence within the area based on the sensor map.

14. The method of claim 8, wherein inferring human presence in the known blind spot of the area includes:
receiving data indicating presence of an occupant in a first region of the area;
subsequently receiving data indicating no occupant being detected in the first region and no occupant being detected in a second region of the area neighboring the first region, wherein the known blind spot is in the second region; and
determining, by the processor, that the occupant moved from the first region to the known blind spot in the second region based on no occupant being detected in either of the first or second regions.

15. The method of claim 14, the method further comprising correlating the data indicating presence of the occupant to the first region of the area using a sensor map stored in a memory accessible to the processor.

16. The method of claim 8, the method further comprising providing an output indicating a human presence exists, wherein the output is used to control at least one of an HVAC, a lighting device, window blinds, a surveillance system, and a security system

17. A computer program product including one or more non-transitory processor readable mediums encoded with instructions that when executed by one or more processors cause a process to be carried out for detecting human occupancy, the process comprising:
receiving data representative of a plurality of IR frames captured by an infrared (IR) sensor array configured to scan an area;
detecting human presence and lack of human presence in the area based on heat signature differences indicated in the IR frames; and
inferring human presence in a known blind spot of the area based on detected human presence in non-blind spots neighboring the known blind spot so that entering and exiting with respect to the known blind spot is tracked.

18. The computer program product of claim 17, the process further comprising:
providing an output indicating a human presence exists, wherein the output is used to control at least one of an HVAC, a lighting device, window blinds, a surveillance system, and a security system.

19. The computer program product of claim 17, the process further comprising:
calculating a plurality of average IR frames over various time intervals;
calculating a plurality of delta frames by subtracting a previously calculated average IR frame from a current average IR frame;
calculating a mask frame by summing the plurality of delta frames; and
tracking a position of a human presence based on a value of the mask frame.

20. The computer program product of claim 19, the process further comprising:
determining activity within the area based on the value of the plurality of delta frames.

21. The computer program product of claim 17, wherein a sensor map correlates a first group of one or more pixels of the sensor array to a first region of the area and a second group of one or more pixels of the sensor array to a second region of the area, the process further comprising:
tracking a location of a human presence within the area based on the sensor map.

22. The computer program product of claim 17, wherein inferring human presence in the known blind spot of the area includes:
receiving data indicating presence of an occupant in a first region of the area;
subsequently receiving data indicating no occupant being detected in the first region and no occupant being detected in a second region of the area neighboring the first region, wherein the known blind spot is in the second region; and
determining that the occupant moved from the first region to the known blind spot in the second region based on no occupant being detected in either of the first or second regions.

23. The computer program product of claim 22, the process further comprising:
correlating the data indicating presence of an occupant to the first region of the area using a sensor map stored in a memory accessible to the processor.
